(19) United States
(12) Patent Application Publication
(10) Pub. No.: US 2007/0065115 A1
(43) Pub. Date: Mar. 22, 2007

(54) DATA RECORDING AND RECOMPOSING METHOD AND DATA RECORDING AND RECOMPOSING DEVICE

(76) Inventors: Toshiki Kizu, Yokohama-shi (JP); Keisuke Azuma, Ichikawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/533,645

(22) Filed: Sep. 20, 2006

(30) Foreign Application Priority Data
Sep. 21, 2005 (JP) 2005-274383

(51) Int. Cl. H04N 7/26

(52) U.S. Cl. 386/109

(57) ABSTRACT

A data recording and recomposing method according to one embodiment of the invention includes the following processes. When desired reception data is extracted from one or a plurality of reception data and the extracted reception data is recorded, additional information which represents the data size of the reception data received during a predetermined time interval is recorded. The recorded desired reception data is recomposed while determining the data size to be recomposed per predetermined time interval based on the additional information.

### CROSS-REFERENCE TO RELATED APPLICATIONS

This application is based upon and claims the benefit of priority from prior Japanese Patent Applications No. 2005-274383, filed Sep. 21, 2005, the entire contents of which are incorporated herein by reference.

### BACKGROUND OF THE INVENTION

1. Field of the Invention

The invention relates to a data recording and recomposing method and a recording and recomposing device and, more particularly, to recording and recomposing of packet data, which are used in a terrestrial digital broadcast receiver.

2. Description of the Related Art

In terrestrial digital broadcast, broadcast data is sent as a packet stream in an MPEG2/TS (MPEG2 Transport Stream) format specified by ISO/IEC standard 13818-2. The incoming packet stream is mixed with packets such as NULL packets and the like which are not necessary in recomposition. When the incoming packet stream is recorded without deleting these unnecessary packets, the data size to be recorded becomes large. Hence, it is a common practice not to record packets which are not necessary in recomposition. However, if such measure is taken, it is not possible to avoid deviation of PCR (Program Clock Reference) values included in PCR packets that specify the recomposition timings of moving picture data, audio data, and the like, thus disturbing recomposition at accurate timings.

When a receiving terminal does not always exist in an environment with a good reception condition like digital broadcast for portable terminals, the receiving terminal cannot normally receive all required broadcast data, and loss of packets occurs. When broadcast data is recorded in such environment, PCR values that specify the recomposition timings deviate, and recomposition cannot be done at accurate timings, again.

Conventionally, every time a receiving terminal receives a packet, the reception time is stored, and such reception time data are recorded together with broadcast data as additional information. Upon recomposing the recorded broadcast data, the recomposition timings are determined based on the differences between neighboring reception time data as the additional information.

However, with this method, when the data size to be received per unit time increases, a heavy overhead is imposed on processing for storing reception times, and a processor with higher processing power is required. In an environment with a good reception condition, the reception times need not be stored every time a packet is received. When the reception times are recorded for respective packets to be recorded, since extra data must be recorded, a data area required for recording becomes larger.

### BRIEF SUMMARY OF THE INVENTION

A data recording and recomposing method according to the first aspect of the invention comprises: recording, when desired reception data is extracted from one or a plurality of reception data and the extracted reception data is recorded, additional information which represents a data size of the reception data received during a predetermined time interval; and recomposing, when the recorded desired reception data is recomposed, the desired reception data while determining the data size to be recomposed per predetermined time interval based on the additional information.

A data recording and recomposing device according to the second aspect of the invention comprises: a recording data generation unit configured to record, when desired reception data is extracted from one or a plurality of reception data and the extracted reception data is recorded, additional information which represents a data size of the reception data received during a predetermined time interval; and a recorded data read-out unit configured to recompose, when the recorded desired reception data is recomposed, the desired reception data while determining the data size to be recomposed per predetermined time interval based on the additional information.

### BRIEF DESCRIPTION OF THE SEVERAL VIEWS OF THE DRAWING

FIG. 1 is a sequence chart upon receiving and recording broadcast data in a data recording and recomposing method according to a first embodiment of the invention;

FIGS. 2A, 2B, and 2C are sequence charts upon recomposing recorded data in the data recording and recomposing method according to the first embodiment of the invention;

FIG. 3 is a flowchart upon recomposing moving picture data and audio data in the data recording and recomposing method according to the first embodiment of the invention;

FIG. 4 is a sequence chart upon receiving and recording broadcast data in a data recording and recomposing method according to a second embodiment of the invention;

FIGS. 5A, 5B, and 5C are sequence charts upon recomposing recorded data in the data recording and recomposing method according to the second embodiment of the invention;

FIG. 6 is a block diagram of a data recording and recomposing device according to one embodiment of the invention;

FIG. 7 is a flowchart showing an example of the operation of a recording data generation unit in FIG. 6;

FIG. 8 is a flowchart showing an example of the operation of a recorded data read-out unit in FIG. 6;

FIG. 9 is a flowchart showing an example of the operation of the recorded data read-out unit in FIG. 6; and

FIG. 10 is a block diagram of a terrestrial digital broadcast receiver according to an application example of the invention.

### DETAILED DESCRIPTION OF THE INVENTION

Embodiments of the invention will be described hereinafter with reference to the accompanying drawings. In this description, common reference numerals denote common parts throughout the drawings.

An overview of a data recording and recomposing method according to one embodiment of the invention will be described first. Upon receiving and extracting desired broadcast data from one or a plurality of broadcast data, and recording the broadcast data, a predetermined time interval is statically or dynamically set, and the number of packets received during that time interval is recorded as additional information. Upon recomposition, the recorded additional information is used.

In this way, the number of packets to be originally recomposed can be determined based on the predetermined time interval and the number of packets actually received during that time interval. Even when unnecessary data are deleted, or even when loss of packets occurs due to a very bad reception environment, the recomposition timings can be determined with an accuracy of the time interval selected.

When a predetermined time interval of about 10 ms is set given that moving picture data and audio data are sent relatively early to have a margin for a time period from reception to recompose in consideration of decode time periods, the accuracy is high enough to determine the recomposition timing. In this way, recomposition can be done at accurate timings. Especially, when a receiving terminal exists in an environment with a good reception condition and the buffer size used to store data to be recomposed is sufficiently large, if the interval (about 100 ms to 250 ms) of PCR packets which specify the recomposition timings is set as the predetermined time interval, the accuracy is high enough to determine the recomposition timing.

According to the data recording and recomposing method of the invention, the data size of the additional information to be recorded becomes smaller than the method of recording reception times for respective packets to be recorded as additional information.

Furthermore, when the data recording and recomposing method of the invention is used, the processing volume can be reduced compared to the method of generating additional information every time a packet is received, by increasing the predetermined time interval when the data size to be received becomes large. In this way, the need for a processor with high processing power can be obviated. When the performance of a processor and a recording data area of the receiving terminal have enough margins, the accuracy of the additional information is increased by reducing the predetermined time interval. In this way, the data size of additional information and the accuracy of the recomposition timings can be adjusted depending on the situation.

### FIRST EMBODIMENT

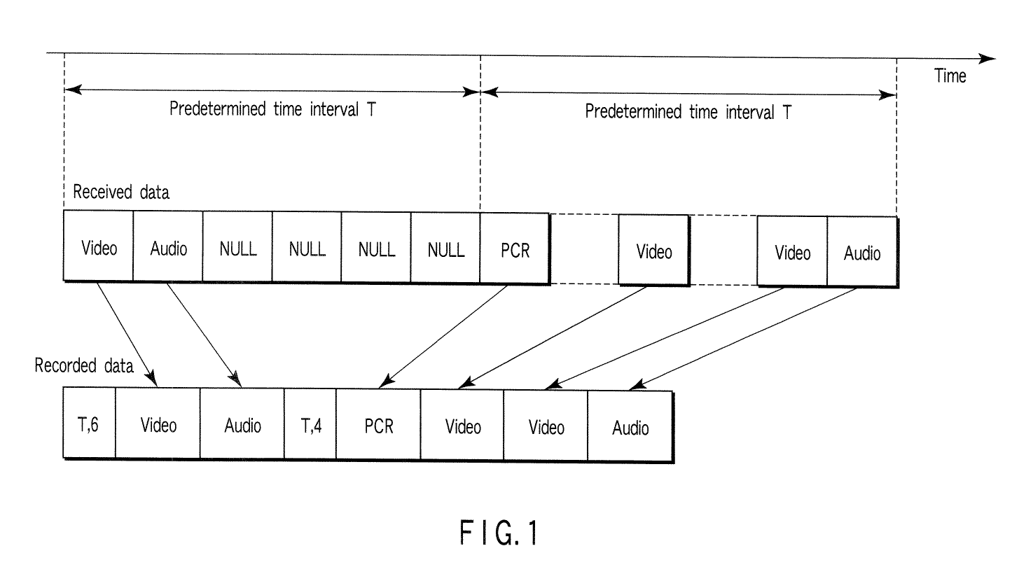

FIG. 1 shows the sequence of packet data in an example of a method of receiving and recording data according to the first embodiment of the data recording and recomposing method of the invention. In this example, assume that data to be received is broadcast data, and packets (Video) including moving picture data, packets (Audio) including audio data, packets (PCR) which specify the recomposition timings, and packets (NULL) which are not necessary in recomposition are received. In case of no loss of packets upon reception, six packets are received during a predetermined time interval T.

If six packets are received during a first time interval T, additional information (T,6) indicating that the six packets are received is recorded in a recording device together with packet data. In this case, if the six packets include four packets which are not necessary in recomposition, only two packets, i.e., Video and Audio packets are actually recorded. If four packets are received during the next time interval T and all the received packets are necessary in recomposition, additional information (T,4) indicating that the four packets are received is recorded, and all the four received packets are recorded. However, at this time, reception of two packets has failed in practice. Note that the additional information such as (T,6), (T,4), or the like need only be distinguished from packets to be originally recorded, and can adopt an arbitrary format.

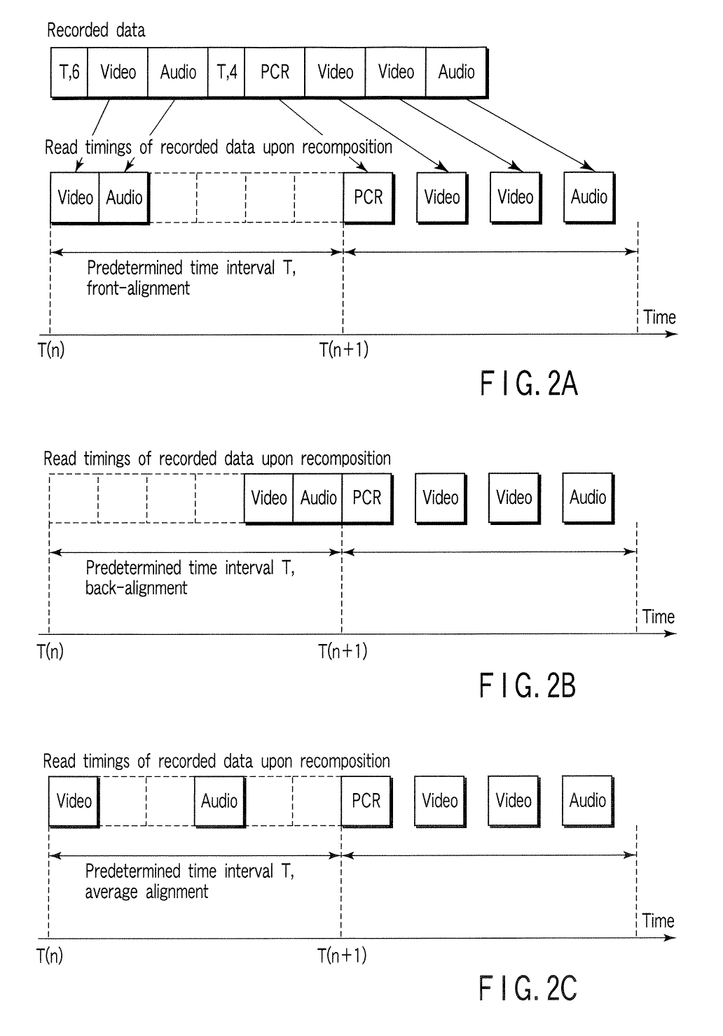

FIGS. 2A, 2B, and 2C show the sequences of packet data in an example of a method of recomposing recorded data shown in FIG. 1. In this example, the numbers of packets received during the predetermined time intervals T are 6 and 4, while the numbers of packets to be recomposed in practice (≦the numbers of received packets) are 2 and 4.

During a period which follows time T(n) in FIGS. 2A, 2B, and 2C, since the number of received packets is 6 and the number of packets to be recomposed is 2, the predetermined time interval T is equally divided into six time periods, and it is determined which of the six time periods is used to read and recompose the two packets. FIG. 2A shows a case wherein the read timings of recorded data are front-aligned. FIG. 2B shows a case wherein the read timings of recorded data are back-aligned. FIG. 2C shows a case wherein the read timings of recorded data are averagely aligned.

Since packets which are not necessary in recomposition have been discarded, the read timings of Video and Audio packets upon recomposition are different between FIG. 1 and FIGS. 2A, 2B, and 2C. During a period that follows time T(n+1) in FIGS. 2A, 2B, and 2C, because the number of received packets is 4 and the number of packets to be recomposed is four, the packets are read and recomposed at timings obtained by equally dividing the predetermined time interval T into four. In this case, reception of two packets has failed in practice. Therefore, the read timings of Video and Audio packets upon recomposition are different when FIG. 1 and FIGS. 2A, 2B, and 2C are compared.

At either time T(n) or T(n+1) in FIGS. 2A, 2B, and 2C, PTS (Presentation Time Stamp) data is normally appended to Video and Audio packets as reference information used to determine the recomposition time. In addition, as the PTS data indicates the time in consideration of a decode time period from the read timing to the recomposition timing of data, even when the read timing has a little bit difference, accurate recomposition is guaranteed.

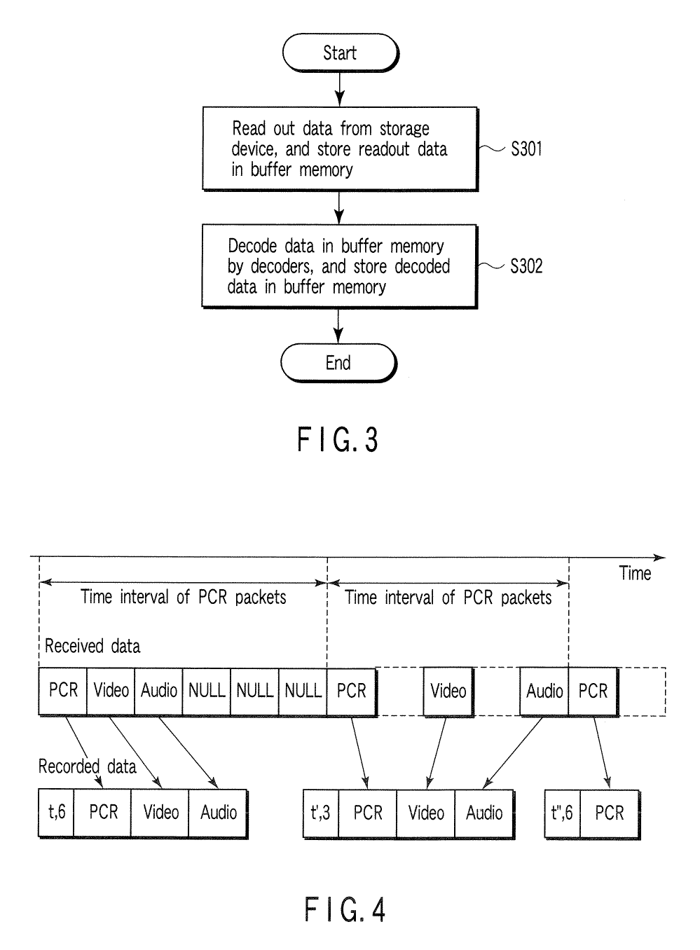

FIG. 3 is a flowchart showing the normal sequence upon recomposing moving picture and audio data in the recomposition method shown in FIGS. 2A, 2B, and 2C. Moving picture and audio data are read out from a storage device, and are stored in a buffer memory (temporary buffer) (S301). Next, a video decoder and audio decoder read out the data from the buffer memory and decode them, and store the decoded data in the buffer memory (S302).

The methods of determining the read timings of packets shown in FIGS. 2A, 2B, and 2C will be compared. The front-alignment method is suited to a case wherein the video decoder and audio decoder have low processing power and take a long processing time period, since a time margin for decode processing increases. By contrast, the back-alignment method is suited to a case wherein a large buffer size used to store temporary data cannot be assured, since the stay time period of data in the temporary buffer becomes short. The average-alignment method is suited to a case wherein the decode processing power and buffer size match the coding algorithm and code size of incoming data.

The read timings of the packets may be determined before the operation based on the decode processing power, buffer size, and the like. Alternatively, the read timings may be dynamically changed upon operation depending on the time margin from when recomposition data is received until it is recomposed after completion of decoding, the use rate of the buffer, and the like.

According to the first embodiment, even when unnecessary data are deleted from broadcast data or even when loss of packets or the like occurs in a very bad reception environment, the recomposition timings are determined with an accuracy of the time interval selected, and recomposition can be made at accurate timings. As a result, the need for recording extra reception time data for respective packets as additional information of broadcast data can be obviated. Also, a data area required for recording can be prevented from being increased. Furthermore, even when the data size to be received per unit time increases, no overhead on processing for storing reception times is required. Moreover, the need for a processor with higher processing power is obviated.

### SECOND EMBODIMENT

In the first embodiment, the generation timing of additional information is the predetermined time interval T. In the second embodiment, the generation timing of additional information is the reception timing of a packet (PCR) that specifies the recomposition timing. That is, a time period from when the previous PCR packet was received until the next PCR packet is received, and the number of all packets received during that time period are recorded as additional information.

FIG. 4 shows the sequence of packet data in a method of receiving and recording broadcast data according to the second embodiment of the data recording and recomposing method of the invention. In this example, assume that packets (Video) including moving picture data, packets (Audio) including audio data, packets (PCR) which specify the recomposition timings, and packets (NULL) which are not necessary in recomposition are received.

If six packets are received during a first time interval t, additional information (t,6) indicating that the six packets are received is recorded in a storage device together with packet data. If three packets are received during the next time interval t′ and all these packets are necessary in recomposition, additional information (t′,3) indicating that the three packets are received is recorded, and all these three received packets are recorded. If six packets are received during the next time interval t″, additional information (t″,6) indicating that the six packets are received is recorded.

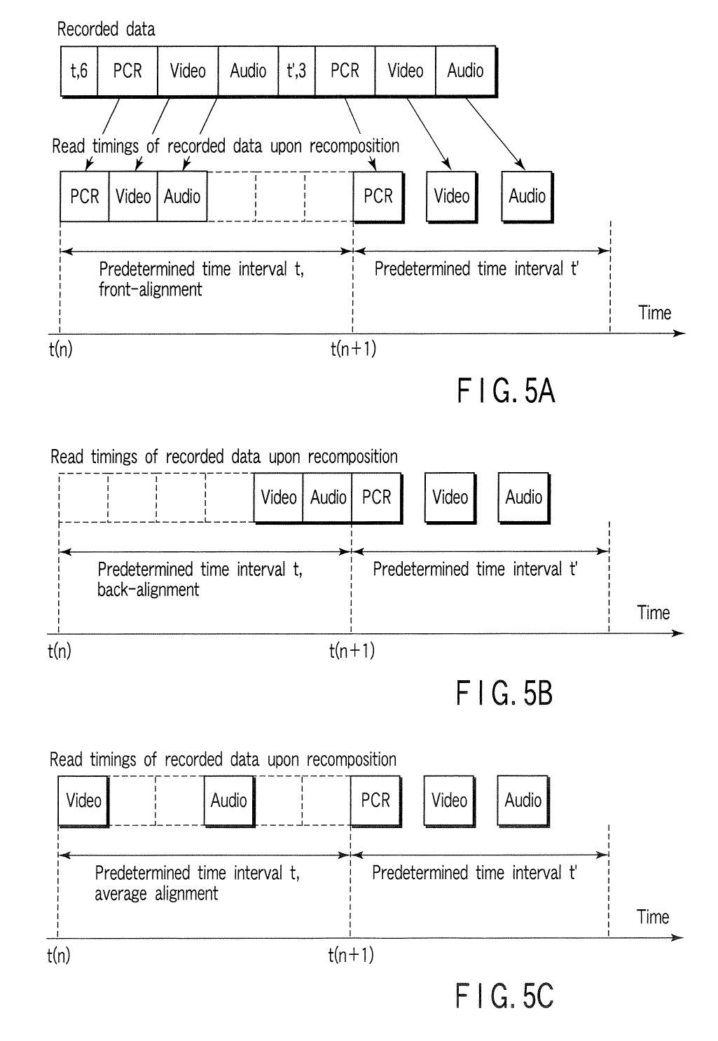

FIGS. 5A, 5B, and 5C show the sequences of packet data in an example of a method of recomposing recorded data shown in FIG. 4. In this example, the number of packets received during the time interval t is 6, the number of packets to be recomposed actually is 3, the number of packets received during the time interval t′ is 3, and the number of packets to be recomposed actually is 3.

During a period which follows time t(n) in FIGS. 5A, 5B, and 5C, the time interval t is equally divided into six time periods, and it is determined which of the six time periods is used to read and recompose the three packets. FIG. 5A shows a case wherein the read timings of recorded data are front-aligned. FIG. 5B shows a case wherein the read timings of recorded data are back-aligned. FIG. 5C shows a case wherein the read timings of recorded data are averagely aligned. The read timings of the packets may be determined before the operation based on the decode processing power, buffer size, and the like. Alternatively, the read timings may be dynamically changed upon operation depending on a time margin from when recomposition data is received until it is recomposed after completion of decoding, the use rate of the buffer, and the like. However, since packets which are not necessary in recomposition have been discarded, the read timings of Video and Audio packets upon recomposition are different between FIG. 4 and FIGS. 5A, 5B, and 5C. In this case, PTS data is normally appended to Video and Audio packets as reference information used to determine the recomposition time. In addition, since the PTS data indicates the time in consideration of a decode time period from the read timing to the recomposition timing of data, even when the read timing has a small difference, accurate recomposition is guaranteed.

During a period that follows time t(n+1) in FIGS. 5A, 5B, and 5C, since the number of packets received during the time interval t′ is 3 and the number of packets to be recomposed is 3, the packets are read and recomposed at timings obtained by equally dividing t′. In this case, the number of packets to be received during the time interval t′ is unknown and, therefore, whether or not all packets are successfully received without any omission is unknown. However, as in case of time t(n), since PTS data used to determine the recomposition time is appended to Video and Audio packets, even when the read timing has a little bit difference, accurate recomposition is guaranteed.

Furthermore, the interval of PCR packets is larger by about several times than the frame recomposition interval of moving picture and audio data. However, when the reception condition is good and loss of packets occurs less frequently, accurate recomposition can be made.

### THIRD EMBODIMENT

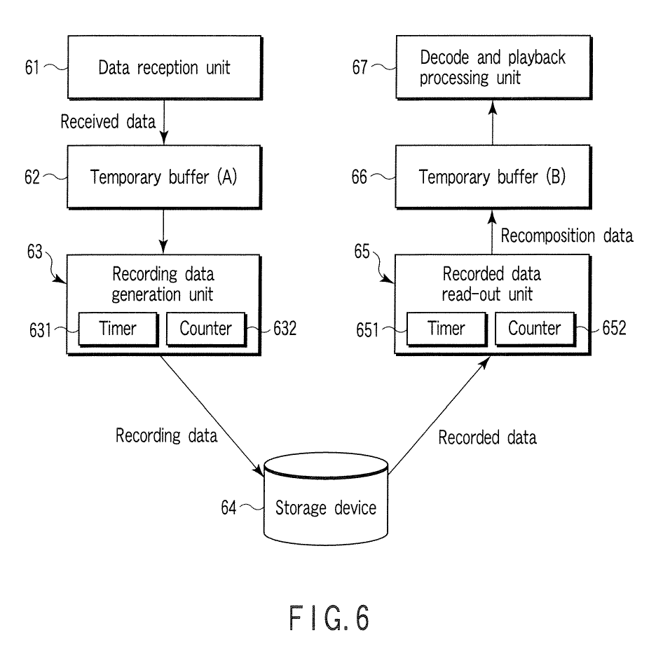

FIG. 6 shows a schematic arrangement of a data recording and recomposing device according to one embodiment of the invention. A data reception unit 61 receives broadcast data, and stores the received data in a temporary buffer (A) 62. A recording data generation unit 63 has a timer 631 for measuring a predetermined time interval, and a counter 632 for storing the number of packets of the received data received from the data reception unit 61, and writes the processing result in a storage device 64. A recorded data read-out unit 65 has a timer 651 for measuring a predetermined time interval, and a counter 652 for reading out recorded data from the storage device 64, and storing the number of packets, and stores the processing result in a temporary buffer (B) 66. A decode and playback processing unit 67 reads out and decodes recomposition data stored in the temporary buffer (B) 66, and plays back the decoded data according to information used to control the recomposition time such as PTS and the like.

The operation upon recording broadcast data in the data recording and recomposing device shown in FIG. 6 is as follows. The data reception unit 61 receives broadcast data and stores it in the temporary buffer (A) 62. The recording data generation unit 63 records the stored broadcast data in the storage device 64 together with additional information, thus implementing recording of the broadcast data.

The operation upon playing back the recorded broadcast data is as follows. The recorded data read-out unit 65 reads out data from the storage device 64, and stores the readout data in the temporary buffer (B) 66. The decode and playback processing unit 67 applies decode processing and playback processing to the stored recomposition data, thus implementing recording and recomposing of the broadcast data.

Note that the temporary buffer (A) 62 and temporary buffer (B) 66 may share a single buffer if recording and recomposing are not executed at the same time. In this case, an area for the temporary buffer can be reduced.

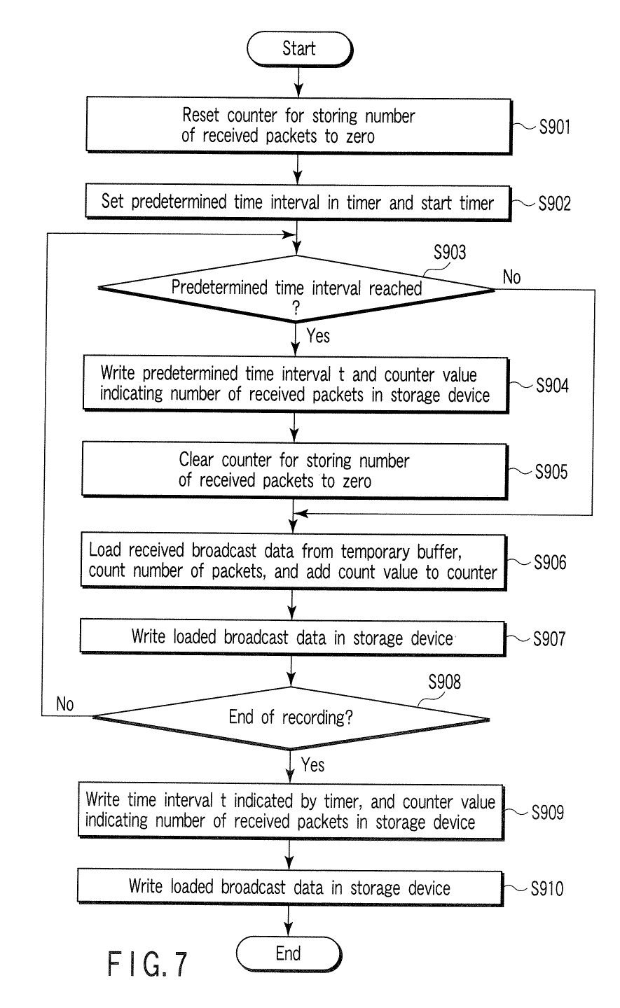

FIG. 7 is a flowchart showing an example of the operation of the recording data generation unit 63 in FIG. 6. The recording data generation unit 63 initializes the counter 632 for storing the number of received packets (S901). The recording data generation unit 63 sets a predetermined time interval in the timer 631 for measuring the predetermined time interval, and starts the timer 631 (S902). The recording data generation unit 63 then checks the timer 631 to see if the predetermined time interval has elapsed (S903). If the predetermined time interval has elapsed, the recording data generation unit 63 writes the predetermined time interval and the value (=the number of received packets) of the counter 632 in the storage device 64 as additional information (S904), and resets the counter 632 to zero (S905). After that, the recording data generation unit 63 reads out received data stored in the temporary buffer (A) 62, counts the number of packets, and increments the counter 632 accordingly (S906). In addition, the recording data generation unit 63 writes the received data in the storage device 64 (S907). A series of operations in steps S903 to S907 are repeated until the end of recording. In case of the end of recording (S908), the recording data generation unit 63 writes the time period indicated by the timer 631 and the counter value indicating the number of packets received so far in the storage device 64 (S909), and writes loaded broadcast data in the storage device 64 (S910).

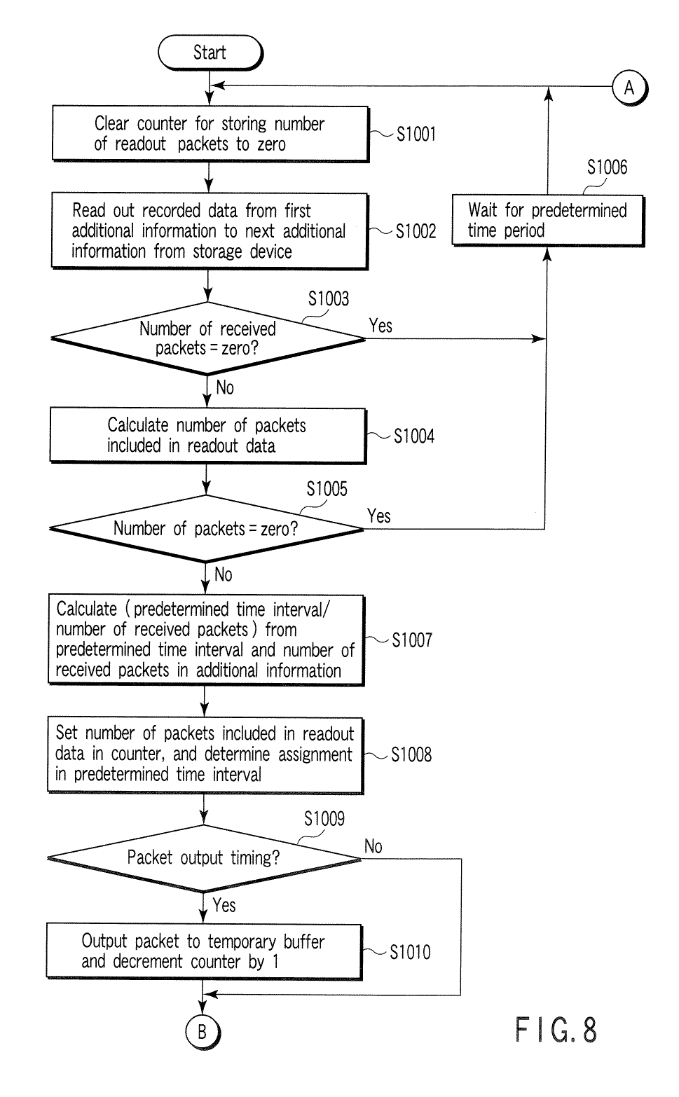

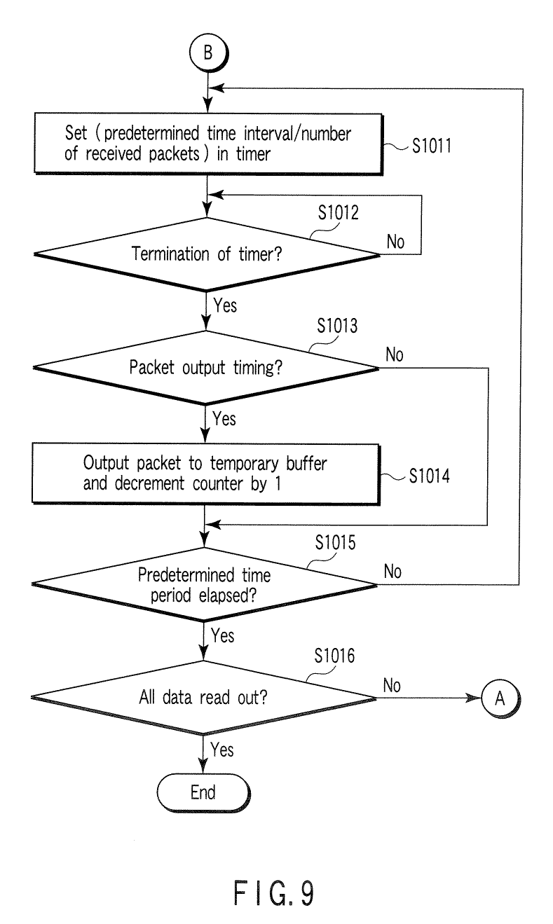

FIGS. 8 and 9 are flowcharts showing an example of the operation of the recorded data read-out unit 65 in FIG. 6. Initially, the recorded data read-out unit 65 clears the counter 652 for storing the number of readout packets to zero (S1001). The recorded data read-out unit 65 reads out data from the first additional information to the next additional information recorded in the storage device 64 (S1002). At this time, the recorded data read-out unit 65 checks the number of received packets recorded in the additional information (S1003). If the number of received packets is zero, since there is no packet to be read out during this time interval, the process waits for a predetermined time period (S1006), and returns to step S1001. If the number of received packets is not zero, the recorded data read-out unit 65 counts the number of packets included in the readout data (S1004). The recorded data read-out unit 65 checks the number of packets included in the readout data (S1005), and if the number of readout packets is zero, the process waits for the predetermined time period, and returns to step S1001.

If the number of packets included in the readout data is not zero, the recorded data read-out unit 65 calculates (the predetermined time interval/the number of received packets) based on the predetermined time interval and the number of received packets according to the additional information (S1007). The recorded data read-out unit 65 sets the number of packets included in the readout data in the counter 652, and determines the output timings of packets to the temporary buffer (B) 66 based on the value of (the predetermined time interval/the number of received packets) (S1008). The recorded data read-out unit 65 checks if the packet output timing has been reached (S1009). If the output timing has been reached, the recorded data read-out unit 65 outputs one packet to the temporary buffer (B) 66, and decrements the counter 652 by 1 (S1010). Next, the recorded data read-out unit 65 sets the value of (the predetermined time interval/the number of received packets) in the timer 651 (S1011), and waits for termination of the timer 651 (S1012). If the timer 651 has terminated, the recorded data read-out unit 65 checks if the packet output timing has been reached (S1013). If the output timing has been reached, the recorded data read-out unit 65 outputs one packet to the temporary buffer (B) 66, and decrements the counter 652 by 1 (S1014). The recorded data read-out unit 65 checks if the predetermined time interval has elapsed (S1015). If the predetermined time interval has elapsed, the recorded data read-out unit 65 checks if all recorded data have been read out (S1016). If data to be read out still remain in the storage device 64, the process returns to step S1001. If the predetermined time interval has not elapsed yet, the process returns to step S1011. If no data remains in the storage device 64, the recorded data read-out unit 65 ends its operation.

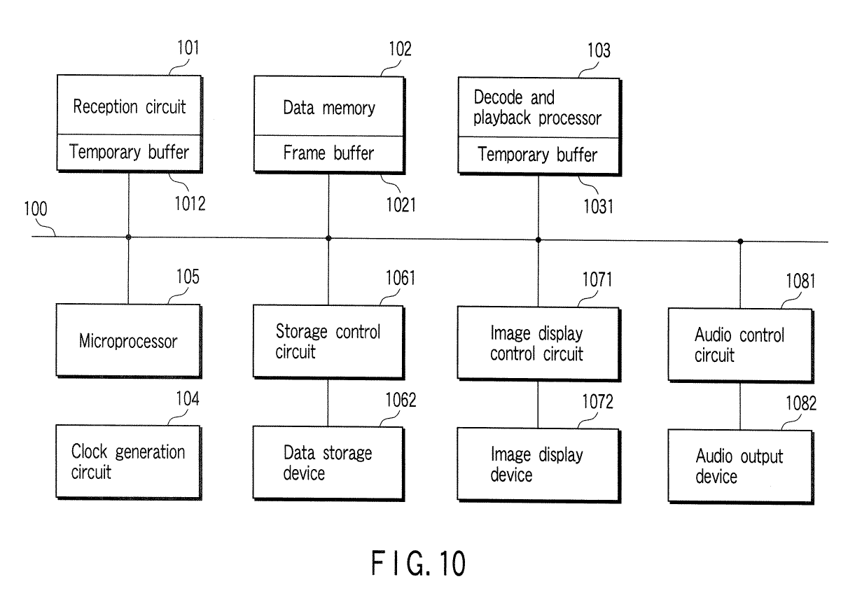

FIG. 10 is a block diagram showing a schematic arrangement of a terrestrial digital broadcast receiver according to one application example of the invention. This receiver includes, e.g., the functions of the data recording and recomposing device shown in FIG. 6.

A reception circuit 101, data memory 102, decode and playback processor 103, and microprocessor 105 are connected to a system bus 100. To the system bus 100, a data storage (e.g., hard disk) device 1062 is connected via a storage control circuit 1061, and an image display device (e.g., liquid crystal display) 1072 is connected via an image display control circuit 1071. Furthermore, to the system bus 100, an audio output device 1082 including a loudspeaker and the like is connected via an audio control circuit 1081.

A clock generation circuit 104 supplies clock signals required for the operations of the entire system. The reception circuit 101 includes a temporary buffer 1012. The reception circuit 101 receives broadcast data, and stores the received data in the temporary buffer 1012. The data memory 102 corresponds to, e.g., the storage device 64 shown in FIG. 6, and allows high-speed processing like a semiconductor memory. The data memory 102 includes a frame buffer 121.

The microprocessor 105 has, e.g., the functions of the recording data generation unit 64 and the recorded data read-out unit 65 shown in FIG. 6, and controls the entire system. The decode and playback processor 103 includes a temporary buffer 1031. The decode and playback processor 103 decodes recomposition data which is stored in the temporary buffer 1031 upon reading out recorded data by the microprocessor 105, and plays back the decoded data according to information used to control the playback time such as PTS and the like. Moving picture data played back in this way is supplied to the image display device 1072 via the image display control circuit 1071, and the image display device 1072 displays a moving picture. On the other hand, played-back audio data is supplied to the audio output device 1082 via the audio control circuit 1081, and the audio output device 1082 outputs an audio. The data storage device 1062 transfers (saves and reads out) data with the data memory 102 via the storage control circuit 1061 as needed.

Since the terrestrial digital broadcast receiver with this arrangement adopts the data recording and recomposing device shown in FIG. 6, the processing volume can be reduced compared to the method of generating additional information every time a packet is received, by increasing the predetermined time interval when the data size to be received becomes large. Hence, a processor with low processing power can be used as the microprocessor 105.

According to the embodiments of the invention, there can be provided a data recording and recomposing method and a data recording and recomposing device which can determine the recomposition timings with an accuracy of the time interval selected and assure recomposition at accurate timings even when unnecessary data are deleted from broadcast data or even when loss of packets or the like takes place in a very bad reception environment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data recording and recomposing method comprising:
recording, when desired reception data is extracted from one or a plurality of reception data and the extracted reception data is recorded, additional information which represents a data size of the reception data received during a predetermined time interval; and
recomposing, when the recorded desired reception data is recomposed, the desired reception data while determining the data size to be recomposed per predetermined time interval based on the additional information.

2. The method according to claim 1, wherein the reception data includes packets, and the additional information represents the number of packets received during the predetermined time interval.

3. The method according to claim 2, wherein the recomposing comprises: equally dividing the predetermined time interval into time periods by the number of packets as the additional information, and recomposing the packets as the desired reception data in the equally divided time periods.

4. The method according to claim 3, wherein when the number of packets as the desired reception data is smaller than the number of packets as the additional information, the packets are recomposed in turn from the earliest time period of the time periods.

5. The method according to claim 3, wherein when the number of packets as the desired reception data is smaller than the number of packets as the additional information, the packets are recomposed in turn to include the latest time period of the time periods.

6. The method according to claim 3, wherein when the number of packets as the desired reception data is smaller than the number of packets as the additional information, the packets are recomposed in time periods averagely assigned in the time periods.

7. The method according to claim 1, wherein the predetermined time interval is shorter than a reception interval of reference packets which specify recomposition timings of the reception data.

8. The method according to claim 1, wherein the predetermined time interval is equal to a reception interval of reference packets which specify recomposition timings of the reception data.

9. The method according to claim 1, wherein the reception data includes at least one of a packet including moving picture data, a packet including audio data, a packet which specifies a recomposition timing, and a packet which is not necessary in recomposition.

10. The method according to claim 1, wherein the data recording and recomposing method is equipped in a terrestrial digital broadcast receiver, moving picture data of data obtained in the recomposing is supplied to an image display device via an image display control circuit, and audio data is supplied to an audio output device via an audio control circuit.

11. A data recording and recomposing device comprising:
a recording data generation unit configured to record, when desired reception data is extracted from one or a plurality of reception data and the extracted reception data is recorded, additional information which represents a data size of the reception data received during a predetermined time interval; and
a recorded data read-out unit configured to recompose, when the recorded desired reception data is recomposed, the desired reception data while determining the data size to be recomposed per predetermined time interval based on the additional information.

12. The device according to claim 11, wherein the reception data includes packets, and the additional information represents the number of packets received during the predetermined time interval.

13. The device according to claim 12, wherein the recorded data read-out unit equally divides the predetermined time interval into time periods by the number of packets as the additional information, and recomposes the packets as the desired reception data in the equally divided time periods.

14. The device according to claim 13, wherein when the number of packets as the desired reception data is smaller than the number of packets as the additional information, the packets are recomposed in turn from the earliest time period of the time periods.

15. The device according to claim 13, wherein when the number of packets as the desired reception data is smaller than the number of packets as the additional information, the packets are recomposed in turn to include the latest time period of the time periods.

16. The device according to claim 13, wherein when the number of packets as the desired reception data is smaller than the number of packets as the additional information, the packets are recomposed in time periods averagely assigned in the time periods.

17. The device according to claim 11, wherein the predetermined time interval is shorter than a reception interval of reference packets which specify recomposition timings of the reception data.

18. The device according to claim 11, wherein the predetermined time interval is equal to a reception interval of reference packets which specify recomposition timings of the reception data.

19. The device according to claim 11, wherein the reception data includes at least one of a packet including moving picture data, a packet including audio data, a packet which specifies a recomposition timing, and a packet which is not necessary in recomposition.

20. The device according to claim 11, wherein the data recording and recomposing device is equipped in a terrestrial digital broadcast receiver, moving picture data of data obtained by the recorded data read-out unit is supplied to an image display device via an image display control circuit, and audio data is supplied to an audio output device via an audio control circuit.
